(19) United States
(12) Patent Application Publication
(10) Pub. No.: US 2014/0267515 A1
(43) Pub. Date: Sep. 18, 2014

(54) AQUEOUS DISPERSIONS COMPRISING NANOCRYSTALLINE CELLULOSE, AND COMPOSITIONS FOR COMMERCIAL INKJET PRINTING

(71) Applicant: Cabot Corporation, Boston, MA (US)

(72) Inventors: Lu Zhang, Providence, RI (US); Elizabeth G. Burns, Windham, NH (US); Tianqi Liu, Boxborough, MA (US); Jodi A. Bates, Chelmsford, MA (US)

(73) Assignee: Cabot Corporation, Boston, MA (US)

(21) Appl. No.: 14/200,975

(22) Filed: Mar. 7, 2014

Related U.S. Application Data
(60) Provisional application No. 61/777,337, filed on Mar. 12, 2013.

(51) Int. Cl. C09D 11/00; B41J 11/00

(52) U.S. Cl. CPC C09D 11/30; B41J 11/002
USPC 347/100; 106/31.13; 106/31.69

(57) ABSTRACT

Disclosed herein are aqueous ink compositions, e.g., inkjet ink compositions, comprising at least one colorant; and a nanocrystalline cellulose present in an amount ranging from 0.5% to 5% by weight, relative to the total weight of the composition. Also disclosed are aqueous dispersions for ink compositions, and methods of commercial inkjet printing.

### RELATED APPLICATION

This application claims priority under 35 U.S.C. §119(e) to U.S. Prov. App. No. 61/777,337, filed Mar. 12, 2013, the disclosure of which is incorporated herein by reference.

### FIELD OF THE INVENTION

Disclosed herein are aqueous dispersions comprising colorants and nanocrystalline cellulose and their use in ink compositions, e.g., inkjet ink compositions. Also disclosed are compositions and methods for commercial inkjet printing.

### BACKGROUND

Due to new and increasing demands of inkjet printing technology, there is a continual need for developing ink compositions to meet the requirements for a multitude of applications. Moreover, the increasing popularity of high speed printing on a variety of substrates requires one or more of improved printing performance, faster drying times, ink stability, etc. Accordingly, there remains a challenge to provide ink components (e.g., vehicle, pigments) that can be tailored to satisfy these needs.

### SUMMARY

One embodiment provides An aqueous inkjet ink composition, comprising:

at least one colorant; and a nanocrystalline cellulose present in an amount ranging from 0.5% to 5% by weight, relative to the total weight of the composition.

Another embodiment provides an aqueous dispersion comprising:

at least one pigment present in an amount ranging from 1% to 25% by weight, relative to the total weight of the composition;

nanocrystalline cellulose present in an amount ranging from 1% to 10% by weight, relative to the total weight of the composition; and

at least one organic solvent present in an amount ranging from 1% to 50% by weight, relative to the total weight of the composition.

Another embodiment provides aqueous dispersion system comprising:

a first aqueous dispersion comprising:
at least one pigment present in an amount ranging from 1% to 25% by weight, relative to the total weight of the composition;
nanocrystalline cellulose present in an amount ranging from 1% to 10% by weight, relative to the total weight of the composition; and
at least one organic solvent present in an amount ranging from 1% to 50% by weight, relative to the total weight of the composition, and

a second aqueous dispersion comprising:
at least one pigment present in an amount ranging from 1% to 25% by weight, relative to the total weight of the composition; and
at least one organic solvent present in an amount ranging from 1% to 50% by weight, relative to the total weight of the composition.

Another embodiment provides a method of commercial inkjet printing, comprising:

providing an inkjet ink composition comprising a pigment; and

ejecting the inkjet ink composition from a stationary printhead onto a continuous paper web at a rate of at least 100 ft/min. to form a printed paper web having a printed image,

wherein the composition is substantially free of a colorant having a calcium binding index value greater than a calcium binding index value of 1,2,3-benzene tricarboxylic acid.

Another embodiment provides a method of commercial inkjet printing, comprising:

providing an inkjet ink composition comprising at least one colorant and a nanocrystalline cellulose; and

ejecting the inkjet ink composition from a stationary printhead onto a continuous paper web at a rate of at least 100 ft/min. to form a printed paper web having a printed image.

### BRIEF DESCRIPTION OF THE DRAWINGS

FIG. 1 is a plot of viscosity (cP) as a function of NCC concentration (wt %);

FIG. 2 is a series of micrographs showing the results of ink drop tests for cyan-control and cyan-NCC formulations for different paper substrates, as described in Example 2;

FIG. 3 is a series of micrographs showing the results of ink drop tests for magenta-control and magenta-NCC formulations for different paper substrates, as described in Example 2;

FIG. 4 is a series of micrographs showing the results of ink drop tests for black-control and black-NCC formulations for different paper substrates, as described in Example 2;

FIG. 5 is a series of micrographs showing the results of ink drop tests for yellow-control and yellow-NCC formulations for different paper types, as described in Example 2;

FIG. 6 is a series of micrographs showing the drying of ink drops at various time intervals for black-control and black-NCC formulations, as described in Example 3;

FIG. 7 is a series of micrographs showing the drying of ink drops at various time intervals for magenta-control and magenta-NCC formulations, as described in Example 3;

FIG. 8 is a series of micrographs showing the drying of ink drops at various time intervals for yellow-control and yellow-NCC formulations, as described in Example 3;

FIG. 9 is a bar plot of optical density on different paper substrates for the control and NCC formulations for the black, cyan, magenta, and yellow pigments, respectively, as described in Example 4;

FIG. 10 is a bar plot of mottle for the control and NCC formulations for the black, cyan, magenta, and yellow pigments, respectively, as described in Example 4;

FIGS. 11(a) to (d) are bar plots of the horizontal edge acuity (a) top edge and (b) bottom edge, and the vertical edge acuity (c) left edge and (d) right edge, as described in Example 4;

FIGS. 12(a) and (b) are bar plots of the horizontal and vertical line intercolor bleed for cyan, magenta, and yellow pigments, respectively, as described in Example 4;

FIG. 13 shows photographs and micrographs (50×) of print patterns provided by yellow-control and yellow-NCC ink formulations, as described in Example 4;

FIG. 14 is a bar plot of mottle for the control and NCC formulations on various paper substrates for the black2, cyan2, magenta2, and yellow2 pigments, respectively, as described in Example 5;

FIGS. 15A and 15B are bar plots of horizontal edge acuity (A) top edge and (B) bottom edge for the control and NCC formulations on various paper substrates for black2, cyan2, magenta2, and yellow2 pigments, respectively, as described in Example 5;

FIGS. 16A and 16B are bar plots of (A) horizontal line intercolor bleed and (B) vertical line intercolor bleed for the control and NCC formulations on various paper substrates for cyan2, magenta2, and yellow2 pigments, respectively, as described in Example 5; and

FIGS. 17A and 17B are plots of particle size growth rate (nm/s) as a function of Ca²⁺ concentration (mM), as described in Example 6.

### DETAILED DESCRIPTION

Disclosed herein are aqueous dispersions and ink compositions (e.g., inkjet ink compositions) comprising nanocrystalline cellulose (NCC). One embodiment provides the aqueous dispersion or ink composition as comprising at least one colorant and a nanocrystalline cellulose.

“Cellulose” refers to a linear chain having a monomer unit of two glucose molecules linked to each other via a β1-4 glycosidic bond. The degree of polymerization, n, for celluloses can range from 10,000 to 15,000. “Nanocrystalline cellulose” as used herein refers to particles comprising cellulose having at least one nanoscale dimension, i.e., less than 1 μm, as determined by TEM. In one embodiment, the nanocrystalline cellulose has a length ranging from 50 nm to 1000 nm and a diameter ranging from 1 nm to 100 nm (diameter encompasses both width and height, which are generally equal on average). In another embodiment, the nanocrystalline cellulose has a diameter ranging from 5 nm to 80 nm and a length ranging from 80 nm to 500 nm, e.g., a diameter ranging from 10 nm to 50 nm and a length ranging from 100 nm to 300 nm. In one embodiment, the nanocrystalline cellulose has an aspect (length/diameter) ratio ranging from 2 to 30, e.g., from 4 to 15, or from 6 to 10. In another embodiment, the nanocrystalline cellulose has a diameter ranging from 1 nm to 100 nm, a length ranging from 50 nm to 1000 nm, and an aspect ratio ranging from 2 to 30; for example, a diameter ranging from 5 nm to 80 nm, a length ranging from 80 nm to 500 nm, and an aspect ratio ranging from 4 to 15; or a diameter ranging from 10 nm to 50 nm, a length ranging from 100 nm to 300 nm, and an aspect ratio ranging from 6 to 10.

In one embodiment, the nanocrystalline cellulose is derived from cellulose obtained from trees, plants, bacteria, algae, and tunicate. Examples of tree and plant sources include wood, cotton, hemp, flax, wheat straw, mulberry, bark, and ramie.

In one embodiment, the nanocrystalline cellulose is self-dispersible in an aqueous solution. In one embodiment, the nanocrystalline cellulose comprises a monomer comprising glucose having at least one anionic group, i.e., glucose derivatized with at least one anionic group. “Anionic group” as used herein refers to groups not native to glucose and encompasses salt forms as well as groups capable of being converted to an anionic group in aqueous solution, i.e., anionizable groups. Exemplary anionizable groups include acids and/or esters. Anionic groups can result from the hydrolysis of cellulose with various diprotic, triprotic or polyprotic acids, e.g., maleic, sulfuric acid, ortho-phosphoric acid, etc., and optionally subsequent reactions to form the acid or ester form. The cellulose that is hydrolyzed can be wood fibers and plant fibers, microcrystalline cellulose (10-50 μm in diameter), microfibrillated cellulose (0.5-10 μm in length), and nanofibrillated cellulose (0.5-2 μm in diameter). In one embodiment, the anionic group is selected from carboxylic acids, sulfates, sulfonic acids, phosphonic acids, and salts and esters and mixtures thereof. In addition to the anionic group, further reactions can be carried out to derivatize the nanocrystalline cellulose, e.g., for rendering the nanocrystalline cellulose more compatible for a particular application. Exemplary additional derivatizations include reactions to form cationic groups, e.g., by reaction with amines or diamines.

Nanocrystalline cellulose comprises crystalline and amorphous regions. In one embodiment, the nanocrystalline cellulose has at least 50% crystallinity (% crystalline regions), e.g., at least 60% crystallinity, or a crystallinity ranging from 50% to 90%.

Nanocrystalline cellulose can increase the viscosity of an aqueous dispersion. In one embodiment, the nanocrystalline cellulose is present in the composition in an amount sufficient to achieve a desired viscosity. In one embodiment, the composition is an inkjet ink composition having a viscosity ranging from 1 cP to 20 cP, e.g., from 1 cP to 15 cP, from 1 cP to 10 cP, from 1 cP to 6 cP, from 3 cP to 10 cP, or from 3 cP to 6 cP.

In one embodiment, the nanocrystalline cellulose is present in the composition in an amount ranging from 0.5% to 5% by weight, relative to the total weight of the composition, e.g., an amount ranging from 0.5% to 4% by weight, from 0.5% to 3% by weight, from 1% to 5% by weight, from 1% to 4% by weight, or from 1% to 3% by weight, relative to the total weight of the composition.

It has also been discovered that the nanocrystalline cellulose itself is dispersible in aqueous solution. One embodiment provides an aqueous dispersion (e.g., an ink or inkjet ink composition) comprising nanocrystalline cellulose having a zeta potential ranging from −20 to −50 mV over a pH ranging from 2 to 11, e.g., a zeta potential ranging from −30 to −50 mV over a pH ranging from 2 to 11.

Often in aqueous dispersions and in inkjet ink compositions, organic solvents have been used to achieve a desired viscosity, such as the levels disclosed herein. It has been discovered, in one embodiment, that the use of nanocrystalline cellulose can reduce the amount of organic solvents present in the dispersion or inkjet ink composition. In one embodiment, the presence of nanocrystalline cellulose in an amount ranging from 0.05% to 5% (or other amounts disclosed herein) reduces the amount of organic solvent to 75% or less of the amount needed without NCC present, e.g., 50% or less, or 25% or less. In one embodiment, the composition is an ink composition (e.g., an inkjet ink composition) and the organic solvent is present in an amount ranging from 1% to 50% by weight, e.g., an amount ranging from 1% to 25% by weight, from 1% to 20% by weight, from 1% to 10% by weight, from 2% to 50% by weight, from 2% to 25% by weight, from 2% to 20% by weight, or an amount ranging from 2% to 10% by weight relative to the total weight of the composition. In one embodiment, the composition is an aqueous dispersion and the organic solvent is present in an amount ranging from 1% to 75% by weight, 1% to 50% by weight, from 1% to 25% by weight, from 1% to 20% by weight, from 1% to 10%, from 5% to 75% by weight, from 5% to 50% by weight, from 5% to 25% by weight, from 5% to 20% by weight, or an amount ranging from 5% to 10% by weight relative to the total weight of the composition. Further details on organic solvents are provided below.

One embodiment provides an aqueous dispersion consisting essentially of (or consisting of):

at least one pigment present in an amount ranging from 1% to 25% by weight, relative to the total weight of the composition;

nanocrystalline cellulose present in an amount ranging from 1% to 10% by weight, relative to the total weight of the composition;

at least one organic solvent present in an amount ranging from 1% to 50% by weight, relative to the total weight of the composition; and

water.

One embodiment provides an aqueous dispersion consisting essentially of (or consisting of):

at least one pigment present in an amount ranging from 1% to 25% by weight, relative to the total weight of the composition;

at least one organic solvent present in an amount ranging from 1% to 50% by weight, relative to the total weight of the composition;

at least one biocide and/or fungicide in an amount ranging from 0.05% to 2% by weight, relative to the total weight of the composition; and

water.

Further details of biocides and fungicides are provided below.

Another embodiment provides an aqueous dispersion system. Typically, aqueous dispersions are provided as base materials to manufacturers for formulating specific compositions, e.g., ink compositions. Additionally, aqueous dispersions typically provide the components in higher concentrations, which upon dilution, achieve the desired concentration in the final composition. However, providing an aqueous dispersion comprising a higher concentration of nanocrystalline cellulose can result in a gel-like composition. Accordingly, a two-component aqueous dispersion system can comprise a first dispersion having a NCC at a concentration greater than that of the final composition, and a second dispersion free of NCC to dilute the first dispersion to a desired level. In one embodiment, the second dispersion has the same components as the first dispersion (e.g., surfactants, humectants, biocides etc.) with the exception of NCC. In one embodiment, the aqueous dispersion system comprises:

a first aqueous dispersion comprising:
at least one pigment present in an amount ranging from 1% to 25% by weight, relative to the total weight of the composition;
nanocrystalline cellulose present in an amount ranging from 1% to 10% by weight, relative to the total weight of the composition; and
at least one organic solvent present in an amount ranging from 1% to 50% by weight, relative to the total weight of the composition, and

a second aqueous dispersion comprising:
at least one pigment present in an amount ranging from 1% to 25% by weight, relative to the total weight of the composition; and
at least one organic solvent present in an amount ranging from 1% to 50% by weight, relative to the total weight of the composition.

With the increasing need for versatile custom-scale commercial printings, inkjet-based technologies have displayed advantages over technologies such as offset technology due to their flexibility and lower cost. Commercial printing (or high speed printing) includes transactional, book printing (trade books, educational books, etc.), direct mail, and magazine printing. Commercial printing differs from desktop/office printing in terms of speed, reliability and print quality.

It has been discovered that non-calcium binding pigments are less affected by paper dust formation compared to calcium binding pigments. Paper dust generated during the printing process can accumulate around the printhead nozzle and contact ink ejected from the nozzle. These effects can be accentuated during commercial printing, where the print speeds and/or volumes are generally higher compared to desktop printing. Because paper dust often contains calcium, pigments that are calcium binding interact with the dust and form particulate matter, which can clog or further clog the nozzle. Accordingly, one embodiment provides a method of commercial inkjet printing, comprising:

providing an inkjet ink composition comprising a pigment selected from oxidized carbon black and pigments having attached at least one organic group; and

ejecting the inkjet ink composition from a stationary printhead onto a continuous paper web at a rate of at least 100 ft/min. to form a printed paper web having a printed image,

wherein the pigment is substantially free of a colorant capable of calcium binding, e.g., a colorant having a calcium binding index value greater than a calcium binding index value of 1,2,3-benzene tricarboxylic acid.

In one embodiment, particulate matter formed from the interaction of calcium binding pigments with calcium present in paper dust can be measured by a test involving the following steps:
printing for a sufficient time to collect a volume of paper dust (e.g., 1 g), which is added to deionized water,
filtering off insoluble material and collecting the supernatant,
analyzing the supernatant by ICP-AES to determine the calcium content,
if calcium is present, adding the supernatant to a calcium binding pigment to dilute the pigment and observing whether particle growth occurred,
determining the concentration Ca2+ required to cause particle size growth of the calcium binding pigment.

It has been observed that when performing high speed printing with calcium binding pigments, a calcium concentration as low as 1 ppm can cause coagulation and eventual dust formation, in addition to the dust formed from the physical effects of printing. Such coagulation may occur at a tip of the print head nozzle and generate flocculated inks.

In one embodiment, the pigment is selected from oxidized carbon blacks and pigments having attached at least one organic group comprising at least one ionic group, at least one ionizable group, and mixtures thereof.

In one embodiment, the pigment is selected from pigments having attached at least one organic group comprising at least one group selected from carboxylic acids, sulfonic acids, hydroxyls, amines, esters, amides, and salts thereof, e.g., hydroxylates, mono-, di-, tri-, and tetra-alkyl ammonium salts. In one embodiment, the alkyl of the ammonium salts is selected from C₁-C₆ alkyls.

In one embodiment, the pigment has attached at least one organic group comprising the formula —[R(A)]-, wherein:
R is attached to the pigment and is selected from arylene, heteroarylene, alkylene, alkarylene, and aralkylene, and
A is selected from carboxylic acids, sulfonic acids, hydroxyls, amines, esters, amides, and salts thereof.

In one embodiment, —[R(A)]- is a terminal group, i.e., attached only to the pigment (e.g., carbon black). In another embodiment, —[R(A)]- is attached to the pigment and at least one other group through the “R” fragment, including, e.g., hydrogen, alkyl, aryl, alkaryl, aralkyl, halide, etc. In one embodiment, —[R(A)]- comprises more than one “(A)” species such that the multiple “(A)” species are not capable of binding calcium. Additional details of the organic group are provided below.

High speed inkjet printing can be either sheet fed or web fed. Web press inkjet printing is a commercial printing technology developed to print on a continuous paper web at rates of hundreds of feet per minute. (In contrast, the rate of desktop printing is generally less than 50 pages per minute for black only.) In one embodiment, the high speed printing is performed at a rate of at least 100 ft/min for four color printing.

In one embodiment, the firing frequency for high speed printing is at least 15 kHz. (Desktop printing firing frequencies are typically less than 15 kHz due to the lower print speeds.)

The paper web is a continuous roll of paper (versus small sheets of paper for desktop printing) that is conveyed along a paper path that includes stationary inkjet printheads (desktop printers have one moving printhead that traverses the width of the paper) for ejecting a series of ink droplets onto the paper web. In one embodiment, after the ink droplets deposit onto the paper, the web then passes through a drying oven, which can be a component of a printer housing the stationary printhead (desktop printers have no dryers). In another embodiment, the paper web passes through rollers to be rewound or through cutters to be cut into sheets. This step can be performed after drying or without drying.

Resolutions can vary and are generally tied to printing speed. Speed and resolution are a function of the printhead used in the press. In one embodiment, the high speed printing methods disclosed herein can provide resolutions as low as 300 dpi or as high as 1600 dpi, typically using slower print speeds but at a speed of at least 100 ft/min. (Desktop printing can print at similar resolutions, but at markedly lower speeds.)

High speed printing substrates can vary from plain porous paper to calendared clay based papers designed specifically for offset (oil based) analog printing inks. Papers can also be further treated (inkjet-treated), e.g., with salts or polymers, to render them more receptive to water-borne inkjet ink. The plain papers in desktop printing can have similar features to the porous papers in high speed printing, including the types of inkjet-treated coatings. However the non-porous papers used in commercial high speed printing differ greatly from the types of non-porous papers used in desktop printing. Ink challenges for high speed commercial printing are obtaining high OD on porous paper at low resolutions as ink droplet spreading competes with penetration. Too much penetration can also cause undesirable strikethrough on porous substrates. With calendared low porous papers, mottle, dry time durability and bleed become particularly challenging for inkjet inks. The use of polymers are required to obtain durability requirements on the non-porous substrates and inkjet-treated coatings can also be employed to improve image quality and dry time.

For commercial printing, dry times can be an issue as the ink needs to set before the printed paper contacts other rollers. If the sheet is too moist, drying can cause issues such as paper cockle. It has been discovered that an inkjet ink composition comprising nanocrystalline cellulose can accelerate the drying process. Accordingly, another embodiment provides a method of commercial inkjet printing, comprising:

providing an inkjet ink composition comprising at least one colorant and a nanocrystalline cellulose; and

ejecting the inkjet ink composition from a stationary printhead onto a continuous paper web at a rate of at least 100 ft/min. to form a printed paper web having a printed image.

In one embodiment, the colorant is selected from pigments, which can be selected from oxidized carbon black and pigments having attached at least one organic group, such as those groups disclosed herein.

In one embodiment, the nanocrystalline cellulose can be present in an amount ranging from 0.5% to 5% or other amounts as disclosed herein.

In one embodiment, the inkjet ink composition can comprise components in the amounts as disclosed herein, e.g., at least one organic solvent.

In one embodiment, the composition printed on the paper web reduces the drying time needed prior to cutting, handling, etc. In one embodiment, the composition reduces drying time to 50% the time or less required for the equivalent composition without nanocrystalline cellulose, e.g., 25% the time or less, or 10% the time or less.

### Colorants

In one embodiment, the aqueous dispersion (e.g., an inkjet ink composition) comprises a colorant selected from dyes and pigments. In one embodiment, the colorant is a dye, such as conventional dyes including food dyes, FD&C dyes, acid dyes, direct dyes, reactive dyes, derivatives of phthalocyanine sulfonic acids, including copper phthalocyanine derivatives, sodium salts, ammonium salts, potassium salts, lithium salts, and the like. Combinations of dyes may also be used in order to form different shades. Examples of acid dyes include, but are not limited to, Acid Red 18, Acid Red 27, Acid Red 52, Acid Red 249, Acid Red 289, Acid Blue 9, Acid Yellow 23, Acid Yellow 17, Acid Yellow 23, and Acid Black 52. Examples of basic dyes include, but are not limited to, Basic Red 1, Basic Blue 3, and Basic Yellow 13. Examples of direct dyes include, but are not limited to, Direct Red 227, Direct Blue 86, Direct Blue 199, Direct Yellow 86, Direct Yellow 132, Direct Yellow 4, Direct Yellow 50, Direct Yellow 132, Direct Yellow 104, Direct Black 170, Direct Black 22, Direct Blue 199, Direct Black 19, and Direct Black 168. Examples of reactive dyes include, but are not limited to, Reactive Red 180, Reactive Red 31, Reactive Red 29, Reactive Red 23, Reactive Red 120, Reactive Blue 49, Reactive Blue 25, Reactive Yellow 37, Reactive Black 31, Reactive Black 8, Reactive Green 19, and Reactive Orange 84. Other types of dyes can also be used, including, for example, Yellow 104 and Magenta 377.

In addition to the colorant (dyes or pigments), the inkjet ink compositions of the present invention may further incorporate additional dyes to modify color balance and adjust optical density. Such dyes include food dyes, FD&C dyes, acid dyes, direct dyes, reactive dyes, derivatives of phthalocyanine sulfonic acids, including copper phthalocyanine derivatives, sodium salts, ammonium salts, potassium salts, and lithium salts.

In one embodiment, the colorant is selected from pigments, which is a solid material, generally in the form of a particulate or in a form readily formed into a particulate, such as a pressed cake. The pigment can be any type of pigment conventionally used by those skilled in the art, such as black pigments and other colored pigments including blue, black, brown, cyan, green, white, violet, magenta, red, orange, or yellow pigments. Mixtures of different pigments can also be used. Representative examples of black pigments include various carbon blacks (Pigment Black 7) such as channel blacks, furnace blacks, gas blacks, and lamp blacks, and include, for example, carbon blacks sold as Regal®, Black Pearls®, Elftex®, Monarch®, Mogul®, and Vulcan® carbon blacks available from Cabot Corporation (such as Black Pearls® 2000, Black Pearls® 1400, Black Pearls® 1300, Black Pearls® 1100, Black Pearls® 1000, Black Pearls® 900, Black Pearls® 880, Black Pearls® 800, Black Pearls® 700, Black Pearls® 570, Black Pearls® L, Elftex® 8, Monarch® 1400, Monarch® 1300, Monarch® 1100, Monarch® 1000, Monarch® 900, Monarch® 880, Monarch® 800, Monarch® 700, Regal® 660, Mogul® L, Regal® 330, Regal® 400, Vulcan® P). Carbon blacks available from other suppliers can be used. Suitable classes of colored pigments include, for example, anthraquinones, phthalocyanine blues, phthalocyanine greens, diazos, monoazos, pyranthrones, perylenes, heterocyclic yellows, quinacridones, quinolonoquinolones, and (thio)indigoids. Such pigments are commercially available in either powder or press cake form from a number of sources including, BASF Corporation, Engelhard Corporation, Sun Chemical Corporation, Clariant, and Dianippon Ink and Chemicals (DIC). Examples of other suitable colored pigments are described in the Colour Index, 3rd edition (The Society of Dyers and Colourists, 1982). In one embodiment, the pigment is a cyan pigment, such as Pigment Blue 15 or Pigment Blue 60, a magenta pigment, such as Pigment Red 122, Pigment Red 177, Pigment Red 185, Pigment Red 202, or Pigment Violet 19, a yellow pigment, such as Pigment Yellow 74, Pigment Yellow 128, Pigment Yellow 139, Pigment Yellow 155, Pigment Yellow 180, Pigment Yellow 185, Pigment Yellow 218, Pigment Yellow 220, or Pigment Yellow 221, an orange pigment, such as Pigment Orange 168, a green pigment, such as Pigment Green 7 or Pigment Green 36, or black pigment, such as carbon black.

In one embodiment, the colorant comprises a pigment and a dye to modify color balance and adjust optical density.

In one embodiment, the pigment is a self-dispersed pigment, e.g., selected from oxidized carbon black and pigments having attached at least one organic group. Such self-dispersed pigments can be prepared by modifying any of the pigments disclosed herein.

In one embodiment, the self-dispersed pigment is an oxidized carbon black. In one embodiment, “oxidized carbon blacks” are carbon black pigments generally having a pH<7.0 that feature surface-bound ionic or ionizable groups such as one or more of alcohols (phenols, naphthols), lactones, carbonyls, carboxyls (e.g., carboxylic acids), anhydrides, ethers, and quinones. The extent of oxidation of carbon black can determine the surface concentration of these groups. In one embodiment, the oxidized carbon black is obtained by oxidizing an unmodified carbon black, e.g., pigments selected from channel blacks, furnace blacks, gas blacks, and lamp blacks. Exemplary unmodified carbon blacks include those commercially available from Cabot Corporation as Regal®, Black Pearls®, Elftex®, Monarch®, Mogul®, and Vulcan®, such as Black Pearls® 1100, Black Pearls® 900, Black Pearls® 880, Black Pearls® 800, Black Pearls® 700, Black Pearls® 570, Elftex® 8, Monarch® 900, Monarch® 880, Monarch® 800, Monarch® 700, Regal® 660, and Regal® 330. Exemplary oxidizing agents for carbon blacks include oxygen gas, ozone, peroxides such as hydrogen peroxide, persulfates such as sodium and potassium persulfate, hypohalites such as sodium hypochlorite, nitric acid, and transition metal-containing oxidants such as permanganate salts, osmium tetroxide, chromium oxides, ceric ammonium nitrates, and mixtures thereof (e.g., mixtures of gaseous oxidants such as oxygen and ozone).

In another embodiment, the oxidized carbon black is obtained from commercial sources, such as Black Pearls® 1400, Black Pearls® 1300, Black Pearls® 1000, Black Pearls® L, Monarch® 1000, Mogul® L, and Regal® 400, available commercially from Cabot Corporation.

In one embodiment, the pigment has attached at least one organic group where an “attached” organic group can be distinguished from an adsorbed group in that a soxhlet extraction for several hours (e.g., at least 4, 6, 8, 12, or 24 hours) will not remove the attached group from the pigment. In another embodiment, the organic group is attached to the pigment if the organic group cannot be removed after repeated washing with a solvent or solvent mixture that can dissolve the starting organic treating material but cannot disperse the treated pigment. In yet another embodiment, “attached” refers to a bond such as a covalent bond, e.g., a pigment bonded or covalently bonded to a nucleophile or organic group.

In one embodiment, the pigment is carbon black having attached at least one organic group. In one embodiment, the at least one organic group comprises a group selected from carboxylic acids, sulfonic acids, phosphonic acids, hydroxyls, amines, and esters, amides, and salts thereof. In another embodiment, the at least one organic group comprises the formula —[R(A)]-, wherein:
R is attached to the carbon black and is selected from arylene, heteroarylene, and alkylene, and
A is selected from carboxylic acids, sulfonic acids, phosphonic acids, hydroxyls, amines, and esters, amides, and salts thereof.

The arylene, heteroarylene, and alkylene can be unsubstituted or substituted. Exemplary arylenes include phenylene, naphthylene, and biphenylene, and exemplary heteroarylenes include phenylene, naphthylene, and biphenylene having a ring carbon substituted with one or more oxygen or nitrogen atoms. In one embodiment, the arylene is a C₅-C₂₀ arylene. Heteroarylenes can be an arylene as defined herein which one or more ring carbon atoms is replaced with a heteroatom, e.g., N, O, and S. The heteroatom can be bonded to other groups in addition to being a ring atom. Alkylenes may be branched or unbranched. The alkylene may be a C₁-C₁₂ alkylene such as methylene, ethylene, propylene, or butylene.

In one embodiment, the attached organic group comprises at least one ionic group, ionizable group, or mixtures of an ionic group and an ionizable group. An ionic group can be either anionic or cationic and can be associated with a counterion of the opposite charge including inorganic or organic counterions, such as Na⁺, K⁺, Li⁺, NH₄⁺, NR′₄⁺, acetate, NO₃⁻, SO₄⁻², R′SO₃⁻, R′OSO₃⁻, OH⁻, or Cl⁻, where R′ represents hydrogen or an organic group, such as a substituted or unsubstituted aryl or alkyl group. An ionizable group is one that is capable of forming an ionic group in the medium of use. Anionic groups are negatively charged ionic groups that can be generated from groups having ionizable substituents that can form anions (anionizable groups), such as acidic substituents. Cationic groups are positively charged organic ionic groups that can be generated from ionizable substituents that can form cations (cationizable groups), such as protonated amines. Specific examples of anionic groups include —COO⁻, —SO₃⁻, —OSO₃⁻, —HPO₃⁻; —OPO₃⁻², or —PO₃⁻², and specific examples of an anionizable group can include —COOH, —SO₃H, —PO₃H₂, —R′SH, or —R′OH, where R′ represents hydrogen or an organic group, such as a substituted or unsubstituted aryl or alkyl group. Also, specific examples of cationic or cationizable groups include alkyl or aryl amines, which can be protonated in acidic media to form ammonium groups —NR′₂H⁺, where R′ represent an organic group, such as a substituted or unsubstituted aryl or alkyl groups. Organic ionic groups include those described in U.S. Pat. No. 5,698,016, the disclosure of which is incorporated herein by reference.

In one embodiment, the attached organic group comprises a polymer. In one embodiment, the polymer comprises at least one non-ionic group. Examples include alkylene oxide groups of from about 1 to about 12 carbons and polyols, such as a —CH₂—CH₂—O— group, a —CH(CH₃)—CH₂—O— group, a —CH₂—CH(CH₃)—O— group, a —CH₂CH₂CH₂—O— group, or combinations thereof. These non-ionic groups may further comprise at least one ionic or ionizable group as disclosed herein.

In one embodiment, the polymer has a low acid number. In one embodiment, the polymer may be an acidic group containing polymer having an acid number of less than or equal to about 200, such as less than or equal to about 150, less than or equal to about 110, or less than or equal to about 100. In another embodiment, the acid number of the polymer is greater than or equal to about 30. Thus, the polymer may be an acidic group containing polymer having an acid number of from about 30 to about 200, such as from about 30 to about 110, from about 110 to about 150, or from about 150 to about 200

In one embodiment, the carbon black is modified with at least one organic group via a diazonium treatment as detailed, for instance, in the following patents: U.S. Pat. Nos. 5,554,739; 5,630,868; 5,672,198; 5,707,432; 5,851,280; 5,885,335; 5,895,522; 5,900,029; 5,922,118; 6,042,643; 6,534,569; 6,398,858 and 6,494,943 (high shear conditions) U.S. Pat. Nos. 6,372,820; 6,368,239; 6,350,519; 6,337,358; 6,103,380; 7,173,078; 7,056,962; 6,942,724; 6,929,889; 6,911,073; 6,478,863; 6,472,471; and WO 2011/143533, the disclosures of which are incorporated herein by reference. In one embodiment, the attachment is provided via a diazonium reaction where the at least one organic group has a diazonium salt substituent. In another embodiment, the direct attachment can be formed by using the diazonium and stable free radical methods described, for instance, in U.S. Pat. Nos. 6,068,688; 6,337,358; 6,368,239; 6,551,393; 6,852,158, the disclosures of which are incorporated herein by reference, which makes use of reacting at least one radical with at least one particle, wherein a radical is generated from the interaction of at least one transition metal compound with at least one organo-halide compound in the presence of one or more particles capable of radical capture, and the like. In yet another embodiment, the at least one carbon black can be modified (e.g., to attach functional groups) by using the methods of U.S. Pat. Nos. 5,837,045, 6,660,075 and WO 2009/048564 (reaction with organic compounds containing a C—C double bond or triple bond activated by at least one substituent) or U.S. Pub. No. 2004/0171725, U.S. Pat. Nos. 6,664,312, 6,831,194 (reaction with anhydride component), U.S. Pat. No. 6,936,097, U.S. Pub. Nos. 2001/0036994, 2003/0101901 (reaction with organic groups having —N═N—N— group), Canadian Patent No. 2,351,162, European Patent No. 1 394 221, and PCT Publication Nos. WO 01/51566 (reaction between at least one electrophile and at least one nucleophile), WO 04/63289, WO 2010/141071 (reaction with H2N-A-Y where A is a heteroatom), and WO 99/23174, the disclosures of which are incorporated herein by reference.

In one embodiment, the dispersion can be formulated to provide an amount of colorant such that the final amount in the inkjet ink composition is effective to provide the desired image quality (for example, optical density) without detrimentally affecting the performance of the inkjet ink. In one embodiment, the colorant (e.g., a pigment) is present in an amount ranging from 1% to 10% by weight, relative to the total weight of the composition, e.g., an amount ranging from 2% to 10% by weight, from 3% to 10% by weight, from 2% to 7% by weight, or from 3% to 7% by weight, relative to the total weight of the composition.

### Dispersions and Ink Compositions

The aqueous dispersions disclosed herein can be used to formulate ink compositions. In one embodiment, the dispersion comprises at least one organic solvent present in an amount ranging from 1% to 50%, or other amounts as disclosed herein. In one embodiment, the organic solvent is soluble or miscible in water. In another embodiment, the organic solvent is chemically stable to aqueous hydrolysis conditions (e.g., reaction with water under heat aging conditions, including, for example, the hydrolysis of esters and lactones). In one embodiment, the organic solvent has a dielectric constant below that of water, such as a dielectric constant ranging from about 10 to about 78 at 20° C. Examples of suitable organic solvents include low molecular-weight glycols (such as ethylene glycol, diethylene glycol, triethylene glycol, tetraethylene glycol, dipropylene glycol, ethylene glycol monomethyl ether, ethylene glycol monoethyl ether, triethylene glycol monomethyl or monoethyl ether, diethylene glycol monomethyl ether, diethylene glycol monoethyl ether, diethylene glycol monobutyl ether, and tetraethylene glycol monobutyl ether); alcohols (such as ethanol, propanol, iso-propyl alcohol, n-butyl alcohol, sec-butyl alcohol, and tert-butyl alcohol, 2-propyn-1-ol (propargyl alcohol), 2-buten-1-ol, 3-buten-2-ol, 3-butyn-2-ol, and cyclopropanol); diols containing from about 2 to about 40 carbon atoms (such as 1,3-pentanediol, 1,4-butanediol, 1,5-pentanediol, 1,4-pentanediol, 1,6-hexanediol, 1,5-hexanediol, 2,6-hexanediol, neopentylglycol (2,2-dimethyl-1,3-propanediol), 1,3-propanediol, 1,4-butanediol, 1,5-pentanediol, 1,6-hexanediol, 1,2,6-hexanetriol, and poly(ethylene-co-propylene) glycol, as well as their reaction products with alkylene oxides, including ethylene oxides, including ethylene oxide and propylene oxide); triols containing from about 3 to about 40 carbon atoms (such as glycerine (glycerol), trimethylolethane, trimethylolpropane, 1,3,5-pentanetriol, 1,2,6-hexanetriol, and the like as well as their reaction products with alkylene oxides, including ethylene oxide, propylene oxide, and mixtures thereof); polyols (such as pentaerythritol); amides (such as dimethyl formaldehyde and dimethyl acetamide); ketones or ketoalcohols (such as acetone and diacetone alcohol); ethers (such as tetrahydrofuran and dioxane); lactams (such as 2-pyrrolidone, N-methyl-2-pyrrolidone, and ∈-caprolactam); ureas or urea derivatives (such as di-(2-hydroxyethyl)-5,5,-dimethyl hydantoin (dantacol) and 1,3-dimethyl-2-imidazolidinone); inner salts (such as betaine); and hydroxyamide derivatives (such as acetylethanolamine, acetylpropanolamine, propylcarboxyethanolamine, and propylcarboxy propanolamine, as well as their reaction products with alkylene oxides). Additional examples include saccharides (such as maltitol, sorbitol, gluconolactone and maltose); sulfoxide derivatives (symmetric and asymmetric) containing from about 2 to about 40 carbon atoms (such as dimethylsulfoxide, methylethylsulfoxide, and alkylphenyl sulfoxides); and sulfone derivatives (symmetric and asymmetric) containing from about 2 to about 40 carbon atoms (such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, and dimethylsulfolane). The organic solvent can comprise mixtures of organic solvents.

The amount of the solvent can be varied depending on a variety of factors, including the properties of the solvent (solubility and/or dielectric constant), the type of colorant, and the desired performance of the resulting inkjet ink composition. The solvent may be used in amounts ranging from 1% to 40% by weight based on the total weight of the inkjet ink composition, including amounts ranging from 1% to 30%, or amounts ranging from 1% to 20%. In another embodiment, the amount of the solvent is greater than or equal to about 2% by weight based on the total weight of the aqueous dispersion or inkjet ink composition, including greater than or equal to about 5% and greater than or equal to about 10% by weight.

In one embodiment, an ink composition (e.g., an inkjet ink composition) comprises at least one surfactant, e.g., when the pigment is not self-dispersible. The at least one surfactant can enhance the colloidal stability of the composition or change the interaction of the ink with either the printing substrate, such as printing paper, or with the ink printhead. Various anionic, cationic and nonionic dispersing agents can be used in conjunction with the ink composition of the present invention, and these may be used neat or as a water solution. In one embodiment, the surfactant is present in an amount ranging from 0.05% to 5%, e.g., an amount ranging from 0.1% to 5%, or from 0.5% to 2%, by weight relative to the total weight of the inkjet ink composition.

Representative examples of anionic dispersants or surfactants include, but are not limited to, higher fatty acid salts, higher alkyldicarboxylates, sulfuric acid ester salts of higher alcohols, higher alkyl-sulfonates, alkylbenzenesulfonates, alkylnaphthalene sulfonates, naphthalene sulfonates (Na, K, Li, Ca, etc.), formalin polycondensates, condensates between higher fatty acids and amino acids, dialkylsulfosuccinic acid ester salts, alkylsulfosuccinates, naphthenates, alkylether carboxylates, acylated peptides, α-olefin sulfonates, N-acrylmethyl taurine, alkylether sulfonates, secondary higher alcohol ethoxysulfates, polyoxyethylene alkylphenylether sulfates, monoglycylsulfates, alkylether phosphates and alkyl phosphates, alkyl phosphonates and bisphosphonates, included hydroxylated or aminated derivatives. For example, polymers and copolymers of styrene sulfonate salts, unsubstituted and substituted naphthalene sulfonate salts (e.g. alkyl or alkoxy substituted naphthalene derivatives), aldehyde derivatives (such as unsubstituted alkyl aldehyde derivatives including formaldehyde, acetaldehyde, propylaldehyde, and the like), maleic acid salts, and mixtures thereof may be used as the anionic dispersing aids. Salts include, for example, Na⁺, Li⁺, K⁺, Cs⁺, Rb⁺, and substituted and unsubstituted ammonium cations. Representative examples of cationic surfactants include aliphatic amines, quaternary ammonium salts, sulfonium salts, phosphonium salts and the like.

Representative examples of nonionic dispersants or surfactants that can be used in ink jet inks of the present invention include fluorine derivatives, silicone derivatives, acrylic acid copolymers, polyoxyethylene alkyl ether, polyoxyethylene alkylphenyl ether, polyoxyethylene secondary alcohol ether, polyoxyethylene styrol ether, ethoxylated acetylenic diols, polyoxyethylene lanolin derivatives, ethylene oxide derivatives of alkylphenol formalin condensates, polyoxyethylene polyoxypropylene block polymers, fatty acid esters of polyoxyethylene polyoxypropylene alkylether polyoxyethylene compounds, ethylene glycol fatty acid esters of polyethylene oxide condensation type, fatty acid monoglycerides, fatty acid esters of polyglycerol, fatty acid esters of propylene glycol, cane sugar fatty acid esters, fatty acid alkanol amides, polyoxyethylene fatty acid amides and polyoxyethylene alkylamine oxides. For example, ethoxylated monoalkyl or dialkyl phenols may be used. These nonionic surfactants or dispersants can be used alone or in combination with the aforementioned anionic and cationic dispersants.

The dispersing agents may also be a polymeric dispersant, e.g., a natural polymer or a synthetic polymer dispersant. Specific examples of natural polymer dispersants include proteins such as glue, gelatin, casein and albumin; natural rubbers such as gum arabic and tragacanth gum; glucosides such as saponin; alginic acid, and alginic acid derivatives such as propyleneglycol alginate, triethanolamine alginate, and ammonium alginate; and cellulose derivatives such as methyl cellulose, carboxymethyl cellulose, hydroxyethyl cellulose and ethylhydroxy cellulose. Specific examples of polymeric dispersants, including synthetic polymeric dispersants, include polyvinyl alcohols, polyvinylpyrrolidones, acrylic or methacrylic resins (often written as “(meth)acrylic”) such as poly(meth)acrylic acid, acrylic acid-(meth)acrylonitrile copolymers, potassium (meth)acrylate-(meth)acrylonitrile copolymers, vinyl acetate-(meth)acrylate ester copolymers and (meth)acrylic acid-(meth)acrylate ester copolymers; styrene-acrylic or methacrylic resins such as styrene-(meth)acrylic acid copolymers, styrene-(meth)acrylic acid-(meth)acrylate ester copolymers, styrene-α-methylstyrene-(meth)acrylic acid copolymers, styrene-α-methylstyrene-(meth)acrylic acid-(meth)acrylate ester copolymers; styrene-maleic acid copolymers; styrene-maleic anhydride copolymers, vinyl naphthalene-acrylic or methacrylic acid copolymers; vinyl naphthalene-maleic acid copolymers; and vinyl acetate copolymers such as vinyl acetate-ethylene copolymer, vinyl acetate-fatty acid vinyl ethylene copolymers, vinyl acetate-maleate ester copolymers, vinyl acetate-crotonic acid copolymer and vinyl acetate-acrylic acid copolymer; and salts thereof.

In one embodiment, in addition to the surfactant, the inkjet ink compositions can further comprise one or more suitable additives to impart a number of desired properties while maintaining the stability of the compositions. Other additives are well known in the art and include humectants, biocides and fungicides, binders such as polymeric binders, pH control agents, drying accelerators, penetrants, and the like. The amount of a particular additive will vary depending on a variety of factors but are generally present in an amount ranging between 0.01% and 40% based on the weight of the inkjet ink composition. In one embodiment, the at least one additive is present in an amount ranging from 0.05% to 5%, e.g., an amount ranging from 0.1% to 5%, or an amount ranging from 0.5% to 2%, by weight relative to the total weight of the inkjet ink composition

Humectants and water soluble organic compounds other than the at least one organic solvent may also be added to the inkjet ink composition of the present invention, e.g., for the purpose of preventing clogging of the nozzle as well as for providing paper penetration (penetrants), improved drying (drying accelerators), and anti-cockling properties. In one embodiment, the humectant and/or water soluble compound is present in an amount ranging from 0.1% to 10%, e.g., an amount ranging from 1% to 10%, or an amount ranging from 0.1% to 5%, or from 1% to 5%.

Specific examples of humectants and other water soluble compounds that may be used include low molecular-weight glycols such as ethylene glycol, diethylene glycol, triethylene glycol, tetraethylene glycol and dipropylene glycol; diols containing from about 2 to about 40 carbon atoms, such as 1,3-pentanediol, 1,4-butanediol, 1,5-pentanediol, 1,4-pentanediol, 1,6-hexanediol, 1,5-hexanediol, 2,6-hexanediol, neopentylglycol (2,2-dimethyl-1,3-propanediol), 1,3-propanediol, 1,4-butanediol, 1,5-pentanediol, 1,6-hexanediol, 1,2,6-hexanetriol, poly(ethylene-co-propylene) glycol, and the like, as well as their reaction products with alkylene oxides, including ethylene oxides, including ethylene oxide and propylene oxide; triol derivatives containing from about 3 to about 40 carbon atoms, including glycerine, trimethylolpropane, 1,3,5-pentanetriol, 1,2,6-hexanetriol, and the like as well as their reaction products with alkylene oxides, including ethylene oxide, propylene oxide, and mixtures thereof; neopentylglycol, (2,2-dimethyl-1,3-propanediol), and the like, as well as their reaction products with alkylene oxides, including ethylene oxide and propylene oxide in any desirable molar ratio to form materials with a wide range of molecular weights; thiodiglycol; pentaerythritol and lower alcohols such as ethanol, propanol, iso-propyl alcohol, n-butyl alcohol, sec-butyl alcohol, and tert-butyl alcohol, 2-propyn-1-ol (propargyl alcohol), 2-buten-1-ol, 3-buten-2-ol, 3-butyn-2-ol, and cyclopropanol; amides such as dimethyl formaldehyde and dimethyl acetamide; ketones or ketoalcohols such as acetone and diacetone alcohol; ethers such as tetrahydrofuran and dioxane; cellosolves such as ethylene glycol monomethyl ether and ethylene glycol monoethyl ether, triethylene glycol monomethyl (or monoethyl)ether; carbitols such as diethylene glycol monomethyl ether, diethylene glycol monoethyl ether, and diethylene glycol monobutyl ether; lactams such as 2-pyrrolidone, N-methyl-2-pyrrolidone and ∈-caprolactam; urea and urea derivatives; inner salts such as betaine, and the like; thio (sulfur) derivatives of the aforementioned materials including 1-butanethiol; t-butanethiol 1-methyl-1-propanethiol, 2-methyl-1-propanethiol; 2-methyl-2-propanethiol; thiocyclopropanol, thioethyleneglycol, thiodiethyleneglycol, trithio- or dithio-diethyleneglycol, and the like; hydroxyamide derivatives, including acetylethanolamine, acetylpropanolamine, propylcarboxyethanolamine, propylcarboxy propanolamine, and the like; reaction products of the aforementioned materials with alkylene oxides; and mixtures thereof. Additional examples include saccharides such as maltitol, sorbitol, gluconolactone and maltose; polyhydric alcohols such as trimethylol propane and trimethylol ethane; N-methyl-2-pyrrolidone; 1,3-dimethyl-2-imidazolidinone; sulfoxide derivatives containing from about 2 to about 40 carbon atoms, including dialkylsulfides (symmetric and asymmetric sulfoxides) such as dimethylsulfoxide, methylethylsulfoxide, alkylphenyl sulfoxides, and the like; and sulfone derivatives (symmetric and asymmetric sulfones) containing from about 2 to about 40 carbon atoms, such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, dimethylsulfolane, and the like. Such materials may be used alone or in combination.

Biocides and/or fungicides may also be added to the aqueous dispersions or inkjet ink composition disclosed herein. Biocides are important in preventing bacterial growth since bacteria are often larger than ink nozzles and can cause clogging as well as other printing problems. Examples of useful biocides include, but are not limited to, benzoate or sorbate salts, and isothiazolinones. In one embodiment, the biocides and/or fungicides are present in an amount ranging from 0.05% to 5% by weight, 0.05% to 2% by weight, 0.1% to 5% by weight, or 0.1% to 2% by weight, relative to the total weight of the composition.

### EXAMPLES

### Materials

Pigments used in the inkjet formulations are available commercially from Cabot Corporation: CAB-O-JET® 450C (cyan), CAB-O-JET® 465M (magenta), CAB-O-JET® 470Y (yellow), CAB-O-JET® 400K (black), CAB-O-JET® 200 (black2), CAB-O-JET® 250 (cyan2), CAB-O-JET® 265 (magenta2), and CAB-O-JET® 270 (yellow2). Nanocrystalline cellulose was obtained from Alberta Innovates Technology Futures. Glycerol and Surfynol® 465 were obtained from Alfa Aesar and Air Products, respectively.

Unless otherwise specified, print performance was evaluated with an Epson C88 printer set to best mode on various paper substrates.

### Example 1

This Example describes the effect of NCC on inkjet ink viscosity. Each sample in the viscosity measurement contained black pigment (4.5 wt %), glycerol (5 wt %), and Surfynol® 465 (1 wt %) in water with varying NCC concentrations as listed in Table 1. The viscosity of all samples (except heat-aging samples) was measured with a Brookfield DV-II+Pro viscometer at 32° C., 50 rpm with 00 spindle. The samples were allowed to run at 50 rpm for 5 min to allow temperature equilibrium and stable viscosity reading. The results are also shown in Table 1.

TABLE 1
Viscosity as a function of NCC concentration

| [NCC] (wt %) | Viscosity (cP) |
|---|---|
| 1.000 | 2.1 |
| 1.500 | 2.8 |
| 2.000 | 3.7 |
| 2.500 | 4.9 |
| 2.750 | 5.6 |
| 2.875 | 5.9 |
| 3.000 | 6.5 |

These results suggest that a targeted ink viscosity can be achieved with the reduction of significant amount of glycerol. For the magenta pigment, a viscosity of 6 cP was achieved with 2.875 wt % NCC with only 5 wt % glycerol, as compared to 40% glycerol in typical commercial ink formulations. Similar experiments were carried out to determine the NCC concentration needed for inks made from cyan, yellow, and black dispersions, and the results are shown in FIG. 1. The amount of nanocrystalline cellulose needed in new ink formulations for the cyan, yellow, and black pigments are 2.6, 2.5, and 2.5 wt %, respectively. Accordingly, new ink formulations (“Sample”) were prepared according to Table 2 below and contrasted with a prior art formulation (“Control”).

TABLE 2
Inkjet ink formulations

| Control | | Sample | |
|---|---|---|---|
| Pigment | 4.5 wt % | Pigment | 4.5 wt % |
| glycerol | 40 wt % | glycerol | 5 wt % |
| Surfynol ® 465 | 1 wt % | Surfynol ® 465 | 1 wt % |
| Water | remainder | NCC | 2.5-2.875 wt %* |
| | | Water | remainder |

*magenta-NCC: 2.875;
cyan-NCC: 2.6;
yellow-NCC: 2.5;
black-NCC: 2.5

### Example 2

This Example describes experiments demonstrating ink drop spreading and interaction with paper substrates, contrasting the performance of the Control inks with NCC-containing inks. The papers used were non-inkjet treated porous paper, inkjet-treated porous paper 1, inkjet-treated porous paper 2, and coated offset paper.

Ink drops (0.5 μL) were dispensed via syringe on each paper substrate. The spreading was monitored under optical microscope (Olympus, model #BX51). FIGS. 2-5 show photographs from the optical microscope at the time of contact between the ink drop and paper substrate (“start”) and after drying (“end”). It can be seen that the NCC-containing ink formulations exhibit reduced ink spreading comparing to the control ink formulation, and this effect is most significant on the porous substrate (non-inkjet treated porous paper), where the Control ink drop spread and wicked throughout the porous substrate upon contact. On the inkjet-treated porous papers 1 and 2, the pigments of the NCC-containing ink formulations did not substantially spread whereas the ink vehicle displayed spreading. On the coated offset paper, the NCC-coated ink drop showed minimal spreading. These differences between NCC inks and control inks may be attributed to their different rheological properties.

For commercial printing applications, paper flexibility has become a high priority with good print performance expected for a variety of papers. The controlled ink drop spreading and ink-paper interaction for the NCC-containing inks indicate their applicability for commercial printing.

### Example 3

This Example describes the effect of NCC on the drying times of inkjet ink formulations in comparison with the control formulations. The drying time is reported as “apparent” dry time, defined as the time required to observe the drying of a 0.5 μL ink drop dispensed via syringe on a paper substrate under a microscope at 50× magnification (Olympus, model #BX51) until no liquid film was observed. The photographs from the optical microscope are shown in FIGS. 6-8 at varying time intervals for the black, magenta, and yellow formulations, respectively, showing three batches for each formulation. It can be seen that the apparent dry time of 0.5 μL black-control ink can be up to 1 hr, while the drying time of the black-NCC inks was reduced significantly to 3˜4 min. Similar improvement was also observed with other pigment types. The improved dry time was also confirmed on prints, where a 5-10 s difference was observed between the control and NCC inks, which is significant for high speed commercial printing applications.

### Example 4

In this Example, the print performance of NCC-containing inks was evaluated in comparison to the control inks on three types of papers: coated offset paper, non-inkjet treated porous paper, and photo paper.

FIG. 9 is a bar plot of O.D. for each formulation. Generally, the O.D. for the non-inkjet treated porous paper is much lower than that on photo and coated offset papers as the latter two are both coated papers. Compared to the control inks, the NCC inks show: (1) improved O.D. on non-inkjet treated porous paper for all four pigments, (2) improved O.D. on coated offset paper for the cyan, magenta, and yellow inks, and (3) improved OD on photo paper for the cyan, magenta, and black inks.

FIG. 10 is a bar plot of mottle data for the control and NCC-containing inks on coated offset paper, which is often used in commercial printing as it is non-porous, coated stock. Generally, poor mottle has been observed with current ink formulation on this type of paper. The NCC-containing inks exhibited a significant decrease in mottle number, suggesting dramatically improved image quality.

FIGS. 11(a)-(d) is a bar plot of the edge acuity given by NCC-containing inks and control inks on coated offset paper, as quantified by: (a) horizontal edge acuity (top edge); (b) horizontal edge acuity (bottom edge); (c) vertical edge acuity (left edge); and (d) vertical edge acuity (right edge). Like mottle, smaller values indicate better image quality. It can be seen that black NCC ink shows better edge acuity comparing to black control ink. For cyan samples, horizontal edge acuity (top edge) for NCC ink and control ink is comparable. The cyan/NCC ink vertical edge acuity (right edge) value is reduced compared to the control ink. For magenta inks, horizontal edge acuity (top edge) and vertical edge acuity (left edge) for NCC ink and control ink are comparable. Magenta NCC ink shows improved horizontal edge acuity (bottom edge) and vertical edge acuity (right edge) in comparison with the control. For yellow NCC inks, horizontal edge acuity (bottom edge), vertical edge acuity (left edge) and vertical edge acuity (right edge), and horizontal edge acuity (top edge) is approximately the same as the control. In general, the NCC-containing inks show improved edge acuity over the control inks.

FIGS. 12(a) and (b) are bar plots of the Horizontal Line InterColor Bleed and Vertical Line InterColor Bleed, respectively, given by NCC inks and control inks on coated offset paper, where a smaller value indicates better image quality. The NCC-containing inks show significant improvement over control inks (the magenta control ink did not give valid number). For example, the value decreases from ˜250 (control ink) to less than 50 (NCC ink) for cyan. FIG. 13 are photographs and microscopic images (50×) of print patterns provided by yellow-control and yellow-NCC inks. Significant differences between the yellow-control ink and yellow-NCC ink in intercolor bleed were observed: for yellow-control, the boundary between the yellow and black region appeared very rough and the black ink has spread into the yellow region. For the NCC ink, a sharp boundary is observed between black and yellow regions, even under a microscope.

### Example 5

This Example provides a comparison of print performance for another series of inks: CAB-O-JET® 200 (black2), CAB-O-JET® 250 (cyan2), CAB-O-JET® 265 (magenta2), and CAB-O-JET® 270 (yellow2), all available commercially from Cabot Corporation. The control inks contained 4.5 wt % pigment, 40 wt % glycerin, remainder water, and the NCC-containing inks contained 4.5 wt % pigment, 5 wt % glycerin, 2.5 wt % NCC, remainder water. Printing was performed on inkjet-treated porous paper 1 and coated offset paper.

FIG. 14 is a bar plot of mottle for the control and NCC inks. It can be seen that the NCC inks show improved mottle for both inkjet-treated porous paper 1 and coated offset paper, with the exception of magenta2 on coated offset paper.

FIGS. 15A and 15B are bar plots of horizontal edge acuity, top and bottom edges, respectively. Generally, an improvement on horizontal edge acuity was observed for both types of paper substrates for the NCC inks, except for the black2 NCC ink on inkjet-treated porous paper 1.

FIGS. 16A and 16B are bar plots of horizontal and vertical line intercolor bleed, respectively, for the cyan2, magenta2, and yellow2 inks. Significant improvement is seen for all the inks on coated offset paper and improvement is seen for inkjet-treated porous paper 1.

### Example 6

This Example describes a paper dust extraction experiment that measures the amount of dust generated by a commercial printing process. Printing was performed with a Kyocera print head operated at a resolution of 600×600. The paper used was inkjet treated uncoated paper.

After printing, 1 g of paper dust sample was collected and placed in 50 g of deionized water for 1 hr at room temp. Insoluble material was filtered off and the resulting clear liquid was collected and analyzed by ICP-AES. Table 3 provides the metal content found in the paper dust/water extract.

TABLE 3
Metal Content in paper dust/water extract

| Element detected (above | | |
|---|---|---|
| detection limit > 0.1) | Quantity | unit |
| Al | 0.22 | ug/gram |
| B | 0.17 | μg/gram |
| Ba | 0.31 | μg/gram |
| Ca | 76 | μg/gram |
| K | 0.34 | μg/gram |
| Mg | 5.43 | μg/gram |
| Na | 8.07 | μg/gram |
| Si | 0.51 | μg/gram |

The extract of paper dust was found to contain 76 ppm of Ca, 5 ppm of Mg and other multivalent metals.

The water extract was then added to a calcium binding pigment (CAB-O-JET® 400) to dilute the pigment to 1 ppm. The particles grew to 300 nm instantaneously. FIG. 21A is a plot of Ca²⁺ concentration versus particle size growth rate (nm/s), which shows that that 0.07 mM or 0.3 ppm of Ca is enough to cause particle size growth of the calcium binding pigment, indicating that 1 g of paper dust in 12.7 L of water (or ink) would cause particle stability issue. Thus, ˜0.00004 g of dust in 0.5 g of ink at a tip of the print head nozzle could generate flocculated inks even at a calcium binding pigment concentration of only 1 ppm.

In contrast, a similar experiment performed with a non-calcium binding pigment CAB-O-JET® 200 required a significantly greater concentration level of pigment to achieve coagulation, as also shown in FIG. 17A. Similar results were shown between a calcium binding magenta pigment CAB-O-JET® 465 versus a non-calcium binding magenta pigment CAB-O-JET® 265, as indicated in FIG. 17B.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. An aqueous inkjet ink composition, comprising:
at least one colorant; and
a nanocrystalline cellulose present in an amount ranging from 0.5% to 5% by weight, relative to the total weight of the composition.

2. The composition of claim 1, wherein the nanocrystalline cellulose comprises a monomer comprising glucose having at least one anionic group.

3. The composition of claim 2, wherein the at least one anionic group is selected from carboxylic acids, hydrogen sulfates, hydrogen phosphates, and salts and esters and mixtures thereof.

4. The composition of claim 2, wherein the at least one anionic group is selected from hydrogen sulfates and salts and esters thereof.

5. The composition of claim 1, wherein the at least one colorant is selected from dyes and pigments.

6. The composition of claim 1, wherein the at least one colorant is a pigment selected from carbon blacks and organic pigments.

7. The composition of claim 5, wherein the pigment is a self-dispersed pigment.

8. The composition of claim 7, wherein the self-dispersed pigment is selected from oxidized carbon blacks and pigments having attached at least one organic group.

9-12. (canceled)

13. The composition of claim 1, wherein the nanocrystalline cellulose has an aspect (length/diameter) ratio ranging from 2 to 30.

14-15. (canceled)

16. The composition of claim 1, wherein the nanocrystalline cellulose has a diameter ranging from 1 nm to 100 nm and a length ranging from 50 nm to 1000 nm.

17-18. (canceled)

19. The composition of claim 1, wherein the nanocrystalline cellulose is present in the composition in an amount ranging from 0.5% to 4% by weight, relative to the total weight of the composition.

20-23. (canceled)

24. The composition of claim 1, wherein the inkjet ink composition has a viscosity ranging from 1 cP to 20 cP.

25-29. (canceled)

30. The composition of claim 1, wherein the nanocrystalline cellulose has a crystallinity of at least 50%.

31. (canceled)

32. An aqueous dispersion comprising:
at least one pigment present in an amount ranging from 1% to 25% by weight, relative to the total weight of the composition;
nanocrystalline cellulose present in an amount ranging from 1% to 10% by weight, relative to the total weight of the composition; and
at least one organic solvent present in an amount ranging from 1% to 50% by weight, relative to the total weight of the composition.

33. The aqueous dispersion of claim 32, wherein the at least one organic solvent comprises glycerol.

34. The aqueous dispersion of claim 32, wherein the nanocrystalline cellulose is present in an amount ranging from 1% to 8% by weight, relative to the total weight of the composition.

35-38. (canceled)

39. The aqueous dispersion of claim 32, wherein the dispersion has a viscosity ranging from 1 cP to 20 cP.

40. (canceled)

41. An aqueous dispersion system comprising:
a first aqueous dispersion comprising:
at least one pigment present in an amount ranging from 1% to 25% by weight, relative to the total weight of the composition;
nanocrystalline cellulose present in an amount ranging from 1% to 10% by weight, relative to the total weight of the composition; and
at least one organic solvent present in an amount ranging from 1% to 50% by weight, relative to the total weight of the composition, and
a second aqueous dispersion comprising:
at least one pigment present in an amount ranging from 1% to 25% by weight, relative to the total weight of the composition; and
at least one organic solvent present in an amount ranging from 1% to 50% by weight, relative to the total weight of the composition.

42. A method of commercial inkjet printing, comprising:
providing an inkjet ink composition comprising a pigment; and
ejecting the inkjet ink composition from a stationary printhead onto a continuous paper web at a rate of at least 100 ft/min. to form a printed paper web having a printed image,
wherein the composition is substantially free of a colorant having a calcium binding index value greater than a calcium binding index value of 1,2,3-benzene tricarboxylic acid, and
wherein the pigment is selected from oxidized carbon blacks and pigments having attached at least one organic group comprising at least one ionic group, at least one ionizable group, and mixtures thereof.

43. The method of claim 42, wherein the pigment is selected from pigment having attached at least one organic group comprising at least one group selected from carboxylic acids, sulfonic acids, hydroxyls, amines, esters, amides, and salts thereof.

44. The method of claim 42, wherein the pigment is selected from pigment having attached at least one organic group comprising at least one group selected from the formula —[R(A)]-, wherein:
R is attached to the pigment and is selected from arylene, heteroarylene, alkylene, alkarylene, and aralkylene, and
A is selected from carboxylic acids, sulfonic acids, hydroxyls, amines, esters, amides, and salts thereof.

45. The method of claim 42, wherein the pigments having attached at least one organic group are selected from carbon blacks.

46. The method of, claim 42 wherein the ejecting is performed at a firing frequency of at least 15 kHz.

47. The method of, claim 42 further comprising the step of drying the printed paper web.

48. The method of claim 47, wherein the drying is performed in a drying oven that is a component of a printer housing the stationary printhead.

49. The method of, claim 42 wherein after the drying, the method further comprises the step of:
(i) cutting the dried paper web into sheets with a cutting device, or
(ii) rewinding the paper web through rollers.

50-51. (canceled)

52. The method of claim 42, wherein the inkjet ink composition further comprises nanocrystalline cellulose.

53. A method of commercial inkjet printing, comprising:
providing an inkjet ink composition comprising at least one colorant and a nanocrystalline cellulose; and
ejecting the inkjet ink composition from a stationary printhead onto a continuous paper web at a rate of at least 100 ft/min. to form a printed paper web having a printed image.
